(19) United States
(12) Patent Application Publication
(10) Pub. No.: US 2010/0278953 A1
(43) Pub. Date: Nov. 4, 2010

(54) MOLD FOR IN-MOLD DECORATION

(76) Inventors: Chien-Yuan Ni, TAIPEI CITY (TW); Chin-Chuan Tsai, TAIPEI CITY (TW); Hsin-Hsiu Tsai, TAIPEI CITY (TW); Ching-Fu Tsai, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/764,982

(22) Filed: Apr. 22, 2010

(30) Foreign Application Priority Data
Apr. 30, 2009 (TW) 098207368

(51) Int. Cl. B29C 33/30

(52) U.S. Cl. 425/150

(57) ABSTRACT

An in-mold roller mold is disclosed. The in-mold roller mold includes a first mold core, a second mold core, and a plurality of first spacing blocks. The second mold core is used for being closed with the first mold core to form a mold cavity. When the first mold core and the second core are closed, the first spacing blocks are sandwiched by the first mold core and the second mold core to maintain a first predetermined distance of the mold cavity.

### CROSS-REFERENCE TO RELATED APPLICATIONS

This Non-provisional application claims priority under 35 U.S.C. §119(a) on Patent Application No(s). 098207368 filed in Taiwan, Republic of China on Apr. 30, 2009, the entire contents of which are hereby incorporated by reference.

### BACKGROUND OF THE INVENTION

1. Field of the Invention

This invention relates to a mold and, more particularly, to a mold for in-mold decoration used to adjust space between a first mold core and a second mold core or between a pressing frame and the second mold core.

2. Description of the Related Art

As far as a plurality of products at the present market are considered, casings of the products, such as a casing of a mobile phone, a casing of a mouse, a casing of an MP3 and so on, are mostly made of plastic. Therefore, types of the products with the casings made of plastic are popular.

Therefore, to improve value-added of the products, manufacturers often change shapes, colors, or patterns of the casings of the products further to attract consumers, for example, a casing of a notebook computer is made of imitation bamboo or a casing of a computer is directly made of bamboo.

For manufacturing plastic casings with pattern, the in-mold decoration (IMD) process is developed.

The IMD process is a technique that a printed decoration sheet or film is first placed in a plastic injected mold, and then plastic or other raw materials is injected at a back surface of the printed sheet or the film to integrally solidify and mold resin and the sheet or the film. In other words, the IMD process is the technique that the insert decoration is performed together with the injection molding to integrally combine a product and a decoration sheet or the film.

The IMD process has the following advantages. First, cost is reduced and the manufacturing process is simplified. The molding and decoration is achieved together in the IMD process. Therefore, the system cost and storage cost are reduced. Second, stability and durability of products are also improved. Since the printing oil is disposed between the sheet or the film and the injected materials, the design pattern is various. Further, patterns sandwiched between the sheet and the injected materials are wear-resistant and incorrodible. In addition, the print patterns can be changed without replacing the mold. Third, a three-dimensional pattern and a various style design can be performed. The patterns, colors, characters, and LOGO may be printed on the flat sheet or the film by screen printing to mold a three-dimensional shape. Therefore, metal electroplating or natural material special designs can be performed, for example, leather, nap, cotton, or wood. Fourth, we do not have to change the molding molds with the different thickness of the film and the mold replacing cost is reduced.

However, the thickness of the film materials provided by different material suppliers are different. Even the thickness in different batches of the film materials provided by the same material supplier may be different slightly. The thickness of the film materials greatly affects the IMD process, the in-mold roller (IMR) process especially. When a first mold core and a second mold core are closed, problems may be happened causing by the films with different thicknesses. If the film is thicker, the pressing frame for tightly pressing a film to the second mold core may destroy the film. If the film is thinner, airtightness of the film, the pressing frame and the second mold core may fail to be conformed to a manufacturing requirement. Once the thickness of the film is changed and the difference is greater than 0.05 mm, the distance between the first mold core and the second mold core or the thickness of the pressing frame will be adjusted to change the space between the first mold core and the second mold core or between the pressing frame and the second mold core correspondingly in the conventional process.

### BRIEF SUMMARY OF THE INVENTION

One objective of this invention is to provide an in-mold roller mold. The in-mold roller mold mainly includes a first mold core, a second mold core, and a plurality of first spacing blocks. The second mold core is used for being closed with the first mold core to form a mold cavity. When the first mold core and the second mold core are closed, the spacing blocks are sandwiched by the first mold core and the second mold core to maintain a first predetermined distance of the mold cavity.

In one embodiment of the invention, the in-mold roller mold may further include a pressing frame disposed around the first mold core and between the first mold core and the second mold core. When the first mold core and the second mold core are closed, the pressing frame presses a first film to the second mold core, and the first spacing blocks are sandwiched by the first mold core and the second mold core to maintain a second predetermined distance between the pressing frame and the second mold core.

The embodiment f the in-mold roller mold provides a simple and effective solution to adjust the space between the first mold core and the second mold core or between the pressing frame and the second mold core. During processing, the in-mold roller mold provides proper space according to different films. Thereby, It effectively solves the problem that the pressing frame may destroy the film or airtightness of the film may be insufficient when the first mold core and the second mold core are closed.

These and other features, aspects, and advantages of the present invention will become better understood with regard to the following description, appended claims, and accompanying drawings.

### BRIEF DESCRIPTION OF THE DRAWINGS

FIG. 1 is a side schematic diagram showing an in-mold roller mold according to one embodiment of the invention, wherein elements between a first mold and a second mold are shown by a sectional diagram;

FIG. 2 is a local enlarged view showing the elements between the first mold and the second mold in FIG. 1;

FIG. 3 is a side schematic diagram showing the in-mold roller mold in FIG. 1 for showing spacing blocks according to another embodiment of the invention;

FIG. 4A is a front view showing a second mold in FIG. 3; and

FIG. 4B is a front view showing a first mold in FIG. 3.

### DETAILED DESCRIPTION OF THE INVENTION

This invention provides an in-mold roller mold for mainly adjusting space between a first mold core and a second mold core or between a pressing frame and the second mold core. The in-mold roller mold may provide proper pressed space according to different films. The embodiments of the invention are described hereinbelow in detail.

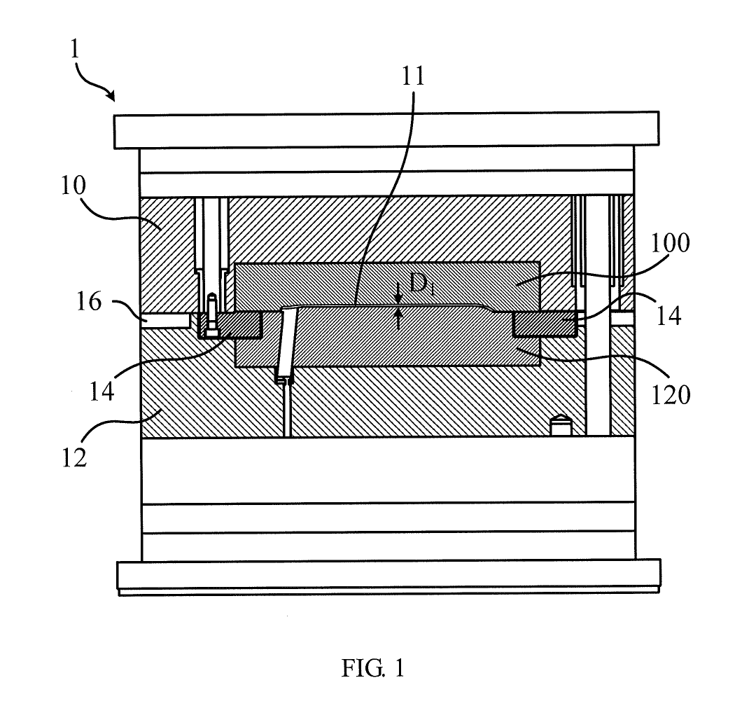

FIG. 1 is a side schematic diagram showing an in-mold roller mold 1 according to one embodiment of the invention. Elements between a first mold 12 and a second mold 10 are shown by the section in FIG. 1. In FIG. 1, the in-mold roller mold 1 in the embodiment is used to a common in-mold roller mold 1 in FIG. 1. However, the invention is not limited thereto. In other words, different kinds of molds at the present may apply the principle of the in-mold roller mold 1 in the embodiment to adjust space between a first mold core 120 and a second mold core 100. The in-mold roller mold 1 mainly includes the first mold 12, the second mold 10, and a plurality of spacing blocks 16. The structures and functions of the interior elements of in-mold roller mold 1 and operating modes thereof in the embodiment of the invention are described hereinbelow in detail.

In FIG. 1, the second mold 10 of the in-mold roller mold 1 includes a second mold core 100. The first mold 12 of the in-mold roller mold 1 includes a first mold core 120. When the first mold core 120 and the second mold core 100 are closed, the second mold core 100 cooperates with the first mold core 120 to form a mold cavity 11. In addition, the spacing blocks 16 are disposed at the first mold 12, the second mold 10, or the first mold 12 and the second mold 10. That is, the spacing blocks 16 are disposed around the first mold core 120, the second mold core 100, or the first mold core 120 and the second mold core 100. Thereby, as shown in FIG. 1, when the first mold core 120 and the second mold core 100 are closed, the spacing blocks 16 are sandwiched by the first mold core 120 and the second mold core 100 to maintain a first predetermined distance D₁ of the mold cavity 11.

In the embodiment, the in-mold roller mold 1 may be used for placing a first film. Further, the in-mold roller mold 1 can include a pressing frame 14. The pressing frame 14 of the in-mold roller mold 1 may be disposed at the first mold 12 and located between the first mold 12 and the second mold 10.

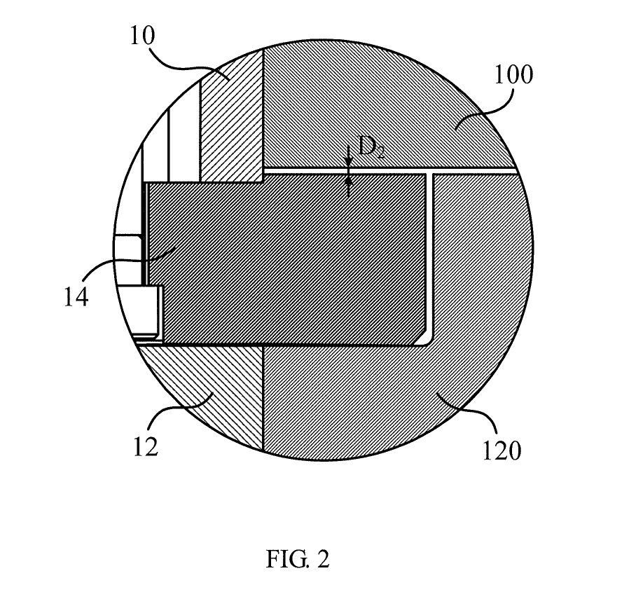

FIG. 2 is a local enlarged view showing elements between the first mold 12 and the second mold 10 in FIG. 1. In FIG. 2, when the first mold core 120 and the second mold core 100 are closed, the pressing frame 14 presses a first film to the second mold core 100. Further, the spacing blocks 16 are sandwiched by the first mold core 120 and the second mold core 100 to maintain a second predetermined distance D₂ between the pressing frame 14 and the second mold core 100.

Generally speaking, when the first mold core 120 and the second mold core 100 are closed, the sandwiched pressure of the in-mold roller mold 1 are centralized between the pressing frame 14 and the second mold core 100. Thus, the first film may be destroyed due to overlarge pressure or airtightness of the first film may be insufficient due to smaller pressure. Therefore, the spacing blocks 16 disposed between the first mold core 120 and the second mold core 100 may disperse the overlarge pressure suffered by the first film.

In the embodiment, the pressing frame 14 of the in-mold roller mold 1 is disposed at the first mold 12. However, the invention is not limited thereto. For example, the pressing frame 14 of the in-mold roller mold 1 may also be disposed at the second mold 10, and the second mold 10 and the pressing frame 14 may be connected with each other by a special linking element. Thereby, when the first film is placed into the in-mold roller mold 1 and is located between the second mold core 100 and the pressing frame 14, the linking element drives the pressing frame 14 to press toward the second mold core 100 to press the first film to the second mold core 100. The embodiment also achieve the objective of using the pressing frame 14 to press the first film to the second mold core 100 as described above.

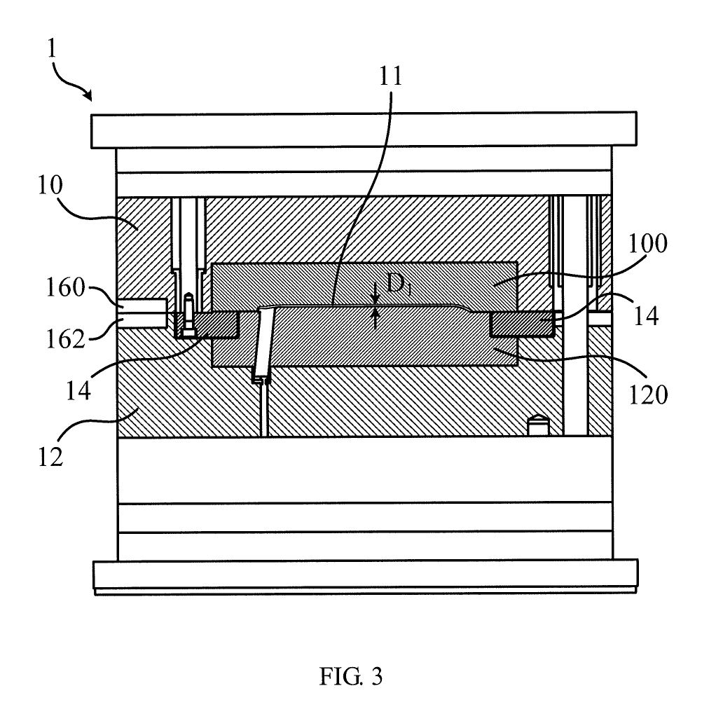

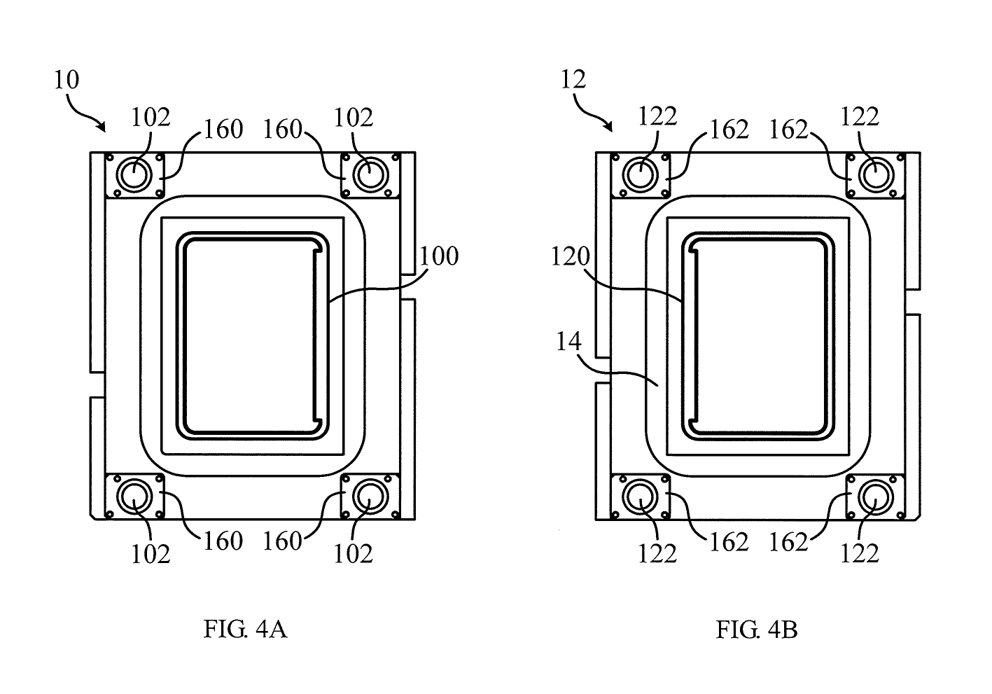

FIG. 3 is a side schematic diagram showing the in-mold roller mold 1 for showing spacing blocks 16 according to another embodiment of the invention. FIG. 4A is a front schematic diagram showing a second mold 10 in FIG. 3. FIG. 4B is a front schematic diagram showing a first mold 12 in FIG. 3. In FIG. 4A, the second mold 10 of the in-mold roller mold 1 includes a plurality of guiding columns 102. In FIG. 4, four guiding columns 102 are taken for example. The number of the guiding columns 102 of the in-mold roller mold 1 is not limited. In addition, in FIG. 4B, the first mold 12 of the in-mold roller mold 1 may correspondingly include a plurality of guiding holes 122 corresponding to the guiding columns 102. Thereby, during a mold closing process, the guiding columns 102 can slidably cooperate with the guiding holes 122, which can maintain a relative position relationship between the first mold core 120 and the second mold core 100 besides guiding the first mold 12 and the second mold 10.

In the embodiment, the guiding columns 102 of the in-mold roller mold 1 are disposed at the second mold 10, and the guiding holes 122 are disposed at the first mold 12. However, the invention is not limited thereto. In other word, the guiding columns 102 of the in-mold roller mold 1 may also be disposed at the first mold 12 and the guiding holes 122 may be correspondingly disposed at the second mold 10. Thereby, during the mold closing process, the guiding columns 102 disposed at the first mold 12 slidably cooperates with the guiding holes 122 disposed at the second mold 10, which also guides the first mold 12 and the second mold 10 and maintain a relative position relationship between the first mold core 120 and the second mold core 100. The disposition of the guiding columns 102 and the guiding holes 122 can be changed according to actual application needs.

In one preferred embodiment, the spacing blocks 16 in FIG. 1 symmetrically disposed around the first mold core 120, the second mold core 100, or the first mold core 120 and the second mold core 100. In addition, in FIG. 3, FIG. 4A, and FIG. 4B, the in-mold roller mold 1 include a plurality of first spacing blocks 162 and a plurality of second spacing blocks 160 corresponding to the first spacing blocks 162. The first spacing blocks 162 are disposed at the first mold 12. That is, the first spacing blocks 162 are disposed around the first mold core 120. The second spacing blocks 160 are disposed at the second mold 10. That is, the second spacing blocks 160 are disposed around the second mold core 100. Further, the first spacing blocks 162 are disposed around the guiding holes 122 disposed at the first mold 12, and the second spacing blocks 160 are disposed around the guiding columns 102 disposed at the second mold 10. In one embodiment, the first spacing blocks 162 and the second spacing blocks 160 have openings for being passed through by the guiding columns 102 during the mold closing process. Thereby, when the first mold core 120 and the second mold core 100 are closed, the first spacing blocks 162 and the second spacing blocks 160 are pressed by each other to maintain a first predetermined distance D₁ between the first mold core 120 and the second mold core 100 and a second predetermined distance D₂ between the pressing frame 14 and the second mold core 100.

In addition, the first spacing blocks 162 are disposed around the guiding holes 122 disposed at the first mold 12, the second spacing blocks 160 are disposed around the guiding columns 102 disposed at the second mold 10 without being passed through by the guiding columns 102. When the first mold core 120 and the second mold core 100 are in the mold closed position, the first predetermined distance D₁ between the first mold core 120 and the second mold core 100 and the second predetermined distance D₂ between the pressing frame 14 and the second mold core 100 are maintained.

The spacing blocks 16 are symmetrically disposed at the first mold 12 and at the periphery without the pressing frame 14 or disposed at the second mold 10 and at the periphery without the pressing frame 14. Thereby, when the first mold core 120 and the second mold core 100 are closed, the first predetermined distance D₁ between the first mold core 120 and the second mold core 100 and the second predetermined distance D₂ between the pressing frame 14 and the second mold core 100 are maintained.

In the embodiment, when the first spacing blocks 162 are disposed around the guiding holes 122 disposed at the first mold 12 and the second spacing blocks 160 are disposed around the guiding columns 102 disposed at the second mold 10, it is easy to maintain the first predetermined distance D₁ and the second predetermined distance D₂ by the rigid structure of the columns 102. In addition, if the first spacing blocks 162 and the second spacing blocks 160 are disposed at the first mold 12 and the second mold 10, respectively, the first spacing blocks 162 and the second spacing blocks 160 directly contact each other in the mold closing process, and the second mold core 100 and the first mold core 120 are not damaged. Therefore, when the size of a formed product fails to conform to specification, only the first spacing blocks 162 and the second spacing blocks 160 need to be replaced. It will effectively reduce the maintenance or the replacement of the second mold core 100 and the first mold core 120.

In another embodiment, a second film provided by another film manufacturer may replace the first film to be placed into the in-mold roller mold 1. The in-mold roller mold 1 may further include a plurality of spacing blocks with different thicknesses. In addition, the spacing blocks with different thicknesses may replace the spacing blocks 16 to be disposed at the first mold 12, the second mold 10, or the first mold 12 and the second mold 10. When the first mold core 120 and the second mold core 100 are closed, the pressing frame 14 press the second film to the second mold core 100, and the spacing blocks with different thicknesses may be sandwiched by the first mold core 120 and the second mold core 100 to maintain a third predetermined distance between the pressing frame 14 and the second mold core 100.

The second predetermined distance D₂ and the third predetermined distance between the pressing frame 14 and the second mold core 100 are determined by the thicknesses of the first film and the second film, respectively. In other words, when the thickness of the second film is greater than that of the first film, the third predetermined distance has to be greater than the second predetermined distance D₂. At that moment, in the in-mold roller mold 1, the spacing blocks 16 with the less thickness need to be replaced by the spacing blocks with the greater thickness thus to allow the pressing frame 14 and the second mold core 100 to maintain the third predetermined distance therebetween. On the other hand, when a thickness of a third film provided by other film manufacturers is less than that of the first film, in the in-mold roller mold 1, the spacing blocks 16 with greater thickness have to be replaced by the spacing blocks with the less thickness thus to allow the pressing frame 14 and the second mold core 100 to maintain a proper predetermined distance therebetween.

In one embodiment, when the second predetermined distance D₂ between the pressing frame 14 and the second mold core 100 needs to be adjusted, the thickness of the second spacing blocks 160 disposed at the second mold 10 keep the same, and the first spacing blocks 162 disposed at the first mold 12 may be detached and replaced by spacing blocks with other thicknesses. Further, the thickness of the first spacing blocks 162 disposed at the first mold 12 keep the same, and the second spacing blocks 160 disposed at the second mold 10 can be detached and replaced by the spacing blocks with other thicknesses.

According to the preferred embodiments of the invention, the in-mold roller mold provides a simple and effective solution to adjust the space between the first mold core and the second mold core or between the pressing frame and the second mold core. Further, the in-mold roller mold provides proper space according to different films during processing. Thereby, the problem that when the in-mold roller mold performs a mold closing action, the pressing frame may destroy the film or airtightness of the film may be insufficient is 0 effectively solved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An in-mold roller mold comprising:
a first mold core;
a second mold core for being closed with the first mold core to form a mold cavity; and
a plurality of first spacing blocks disposed around the first mold core;
wherein when the first mold core and the second mold core are closed, the first spacing blocks are sandwiched by the first mold core and the second mold core to maintain a first predetermined distance of the mold cavity.

2. The in-mold roller mold according to claim 1, further comprising a plurality of guiding columns for guiding the first mold core and the second mold core during a mold closing process.

3. The in-mold roller mold according to claim 2, wherein the first spacing blocks are disposed around the guiding columns.

4. The in-mold roller mold according to claim 3, wherein the first spacing blocks are further disposed through the guiding columns.

5. The in-mold roller mold according to claim 1, wherein the first spacing blocks are symmetrically disposed around the first mold core.

6. The in-mold roller mold according to claim 1, further comprising a plurality of second spacing blocks corresponding to the first spacing blocks and disposed around the second mold core, when the first mold core and the second mold core being closed, the first spacing blocks and the second spacing blocks being sandwiched by the first mold core and the second mold core to maintain the first predetermined distance of the mold cavity.

7. The in-mold roller mold according to claim 1, further comprising a pressing frame disposed around the first mold core and between the first mold core and the second mold core, when the first mold core and the second mold core being closed, the pressing frame pressing a first film to the second mold core, and the first spacing blocks being sandwiched by the first mold core and the second mold core to maintain a second predetermined distance between the pressing frame and the second mold core.
